(19) United States
(12) Patent Application Publication
(10) Pub. No.: US 2004/0214461 A1
(43) Pub. Date: Oct. 28, 2004

(54) CURRENT PATH ON PRINTED CIRCUIT BOARD FOR ELECTROSTATIC DISCHARGE PROTECTION

(76) Inventors: Tung-Wei KAO, Taipei City (TW); Hung-I LAI, Taipei City (TW); Chia-Hung YEN, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,165

(22) Filed: Apr. 19, 2004

(30) Foreign Application Priority Data
Apr. 22, 2003 (TW) 092109555

(51) Int. Cl. H01R 13/53

(52) U.S. Cl. 439/181

(57) ABSTRACT

An electrostatic discharge protection circuit receives an electrostatic discharge current generated by a first printed circuit board and conducted to a first grounding line of the first printed circuit board. The electrostatic discharge protection circuit includes a flexible cable having a connecting line with one end connected to the first grounding line, a second printed circuit board including a fixed component, an electrostatic discharge protection path electrically connected between another end of the connecting line and the fixed component, and a second grounding line electrically connected to the fixed component.

### BACKGROUND OF INVENTION

1. Field of the Invention

The present invention relates to an electrostatic discharge (ESD) protection circuit, and more particularly, to an electrostatic discharge protection circuit for preventing electrostatic discharge current between two separated printed circuit boards.

2. Description of the Prior Art

In general, the human body accumulates electrostatic charge, which can amount to several thousands of volts. If a human body contacts metal or conductive material, such as an IC chip or a circuit board having embedded IC chips, the electrostatic charge on the human body can discharge to the IC chip or the circuit board. This is known as electrostatic discharge (ESD). The electrostatic discharge current can cause damage to the IC chips.

Please refer to FIG. 1. FIG. 1 is a schematic diagram of circuit boards of a conventional slim optical disk drive. The slim optical disk drive includes a sub-board 200 fixed on a tray, a main board 100 fixed on a housing, and a flexible cable 300. The flexible cable 300, which can be a U-shaped flexible cable, can transmit control signals between the main board 100 and the sub-board 200. Although the sub-board 200 slides in and out with the tray, the sub-board 200 can still communicate with the main board 100 via the flexible cable 300.

In general, the sub-board 200 includes a spindle motor 202, a motor driving IC 204, an optical head (not shown in FIG. 1), and an optical head control IC 206. The main board 100 includes an analog signal microprocessor 102, a DSP/Decoder microprocessor 104, a flash ROM 106, and an SDRAM 108. The components on the main board 100 and the components on the sub-board 200 transmit signals among each other via the flexible cable 300. In addition, grounding lines 120 of the main board 100 and grounding lines 220 of the sub-board 200 are electrically connected via a connecting line 320 of the flexible cable 300. A screw 110 fastens the main board 100 to the housing, and the grounding lines 120 are electrically connected to the screw 110. Thus, the housing is electrically connected to ground.

When a user slides an optical disk in or out on the tray, an electrostatic discharge current flows to the grounding lines 220 of the sub-board 200 from the user. In the prior art, the electrostatic discharge current flows from the connecting line 320 to the grounding lines 120 and is then conducted to the screw 110 so as to be released through the housing of the optical disk drive. However, before the electrostatic discharge current flows to the screw 110, the electrostatic discharge current may damage microprocessors or chips on the main board 100 so that the main board cannot function normally.

### SUMMARY OF INVENTION

It is therefore a primary objective of the claimed invention to provide an electrostatic discharge protection circuit to solve the above-mentioned problems.

According to the claimed invention, an electrostatic discharge protection circuit receives an electrostatic discharge current generated by a first printed circuit board and conducted to a first grounding line of the first printed circuit board. The electrostatic discharge protection circuit includes a flexible cable comprising a connecting line having one end connected to the first grounding line, a second printed circuit board including a fixed component, an electrostatic discharge protection path electrically connected between another end of the connecting line and the fixed component, and a second grounding line electrically connected to the fixed component.

According to claimed invention, an electrostatic discharge protection circuit for receiving an electrostatic discharge current generated by an electric appliance includes a fixed component, and an electrostatic discharge protection path on a circuit board for receiving the electrostatic discharge current and conducting the electrostatic discharge current to the fixed component directly.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of circuit boards of a conventional slim optical disk drive.

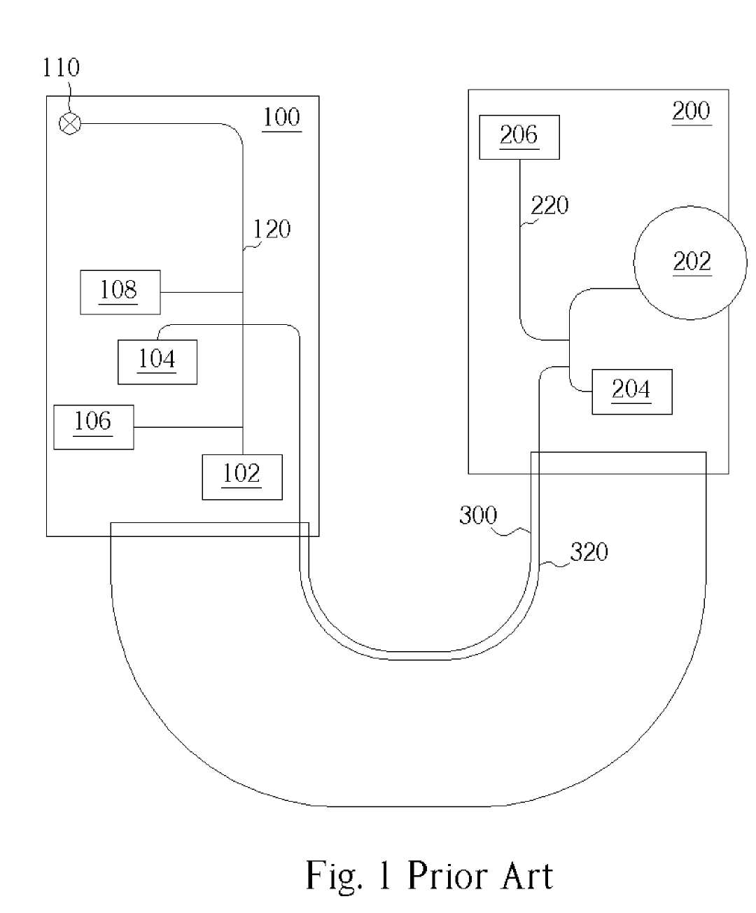

FIG. 2 is a schematic diagram of circuit boards of a slim optical disk drive according to the present invention.

### DETAILED DESCRIPTION

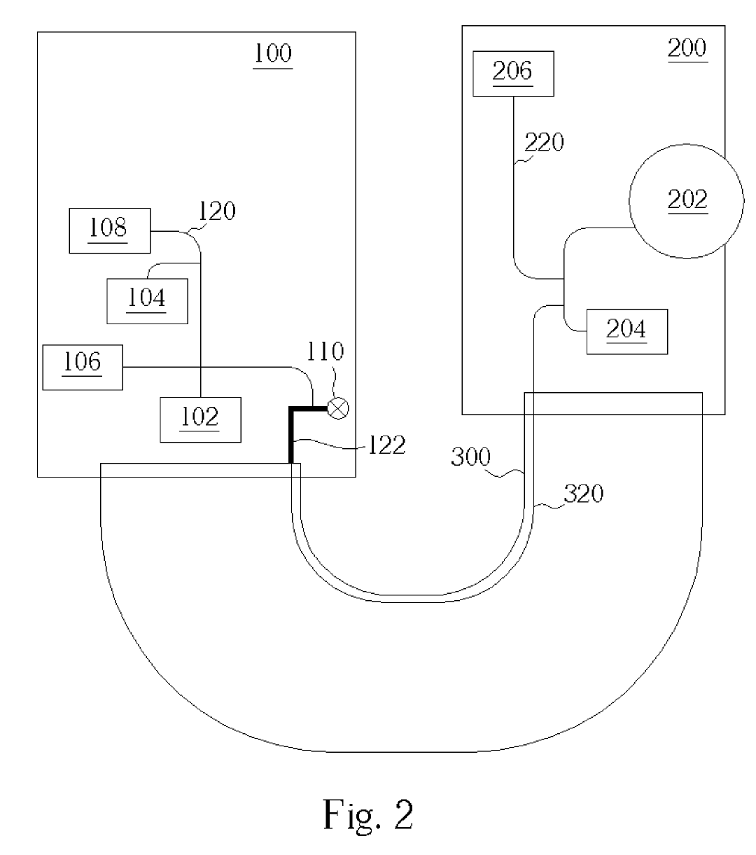

Please refer to FIG. 2. FIG. 2 is a schematic diagram of circuit boards of a slim optical disk drive according to the present invention. Please note that elements with the same reference numerals are substantially the same. An electrostatic discharge protection circuit of the slim optical disk drive according to the present invention includes a sub-board 200 fixed on a tray, a main board 100 fixed on a housing, and a flexible cable 300. The flexible cable 300, which can be a U-shaped flexible cable, can transmit control signals between the main board 100 and the sub-board 200. Although the sub-board 200 slides in out with the tray, the sub-board 200 can still communicate with the main board 100 via the flexible cable 300.

The sub-board 200 includes a spindle motor 202, a motor driving IC 204, an optical head (not shown in FIG. 2), and an optical head control IC 206. The main board 100 includes an analog signal microprocessor 102, a DSP/Decoder microprocessor 104, a flash ROM 106, and an SDRAM 108. The components on the main board 100 and the components on the sub-board 200 transmit signals among each other via the flexible cable 300. The main board 100 further includes a grounding line 120 electrically connected to the analog signal microprocessor 102, the DSP/Decoder microprocessor 104, the flash ROM 106, and the SDRAM 108. The sub-board 200 further includes a grounding line 220 electrically connected to the spindle motor 202, the motor driving IC 204, and the optical head control IC 206. A screw 110 fastens the main board 100 to the housing, and a grounding line is electrically connected to the screw 110. Thus, the housing is electrically connected to ground.

The main board 100 includes an electrostatic discharge protection path 122 electrically connected to one end of a connecting line 320 of the flexible cable 300. One end of the connecting line 320 is electrically connected to the grounding line 220 of the sub-board 200, and the other end of the connecting line 320 is connected to the screw 110 by way of the electrostatic discharge protection path 122 (i.e. directly rather than first passing near components). The width of the electrostatic discharge protection path 122 can be as narrow as 0.7 mm. However, in practice the width of the electrostatic discharge protection path 122 should be greater than 0.15 mm. The grounding line 120 on the main board 100 is connected to the screw 110 directly.

When an electrostatic discharge current flows from the grounding line 220 of the sub-board 200 to the main board 100, the electrostatic discharge current will be conducted to the screw 110 via the electrostatic discharge protection path 122 so that the electrostatic discharge current can be quickly dissipated to the housing of the optical disk drive.

In contrast to the prior art, the electrostatic discharge protection circuit according to the present invention can prevent electrostatic discharge current from passing through microprocessors or chips on the main board so as to protect electric components on the main board. The present invention can prevent damaging effects of electrostatic discharge current so that the main board can work normally.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electrostatic discharge protection circuit for receiving an electrostatic discharge current generated by a first printed circuit board and conducted to a first grounding line of the first printed circuit board, the electrostatic discharge protection circuit comprising:
a flexible cable comprising a connecting line having one end connected to the first grounding line; and
a second printed circuit board comprising:
a fixed component;
an electrostatic discharge protection path electrically connected between another end of the connecting line and the fixed component; and
a second grounding line electrically connected to the fixed component.

2. The electrostatic discharge protection circuit of claim 1 wherein the fixed component is a screw.

3. The electrostatic discharge protection circuit of claim 1 wherein the first printed circuit board is fixed on a tray of an optical disk drive and the second printed circuit board is fixed in a housing of the optical disk drive.

4. The electrostatic discharge protection circuit of claim 3 wherein the optical disk drive is a slim optical disk d rive.

5. The electrostatic discharge protection circuit of claim 1 wherein the width of the electrostatic discharge protection path is greater than the second ground line.

6. The electrostatic discharge protection circuit of claim 1 wherein the flexible cable is a U-shaped flexible cable.

7. An electrostatic discharge protection circuit for receiving an electrostatic discharge current generated by an electric appliance comprising:
a fixed component; and
an electrostatic discharge protection path on a circuit board for receiving the electrostatic discharge current and conducting the electrostatic discharge current to the fixed component directly.

8. The electrostatic discharge protection circuit of claim 7 further comprising a flexible cable connected between the electric appliance and the circuit board, wherein the flexible cable comprises a connecting line for conducting the electrostatic discharge current to the circuit board.

9. The electrostatic discharge protection circuit of claim 8 wherein the flexible cable is a U-shaped flexible cable.

10. The electrostatic discharge protection circuit of claim 7 wherein the fixed component is a screw.

11. The electrostatic discharge protection circuit of claim 7 wherein the electric appliance is fixed on a tray of an optical disk drive and the circuit board is fixed in a housing of the optical disk drive.

12. The electrostatic discharge protection circuit of claim 11 wherein the optical disk drive is a slim optical disk d rive.

13. The electrostatic discharge protection circuit of claim 7 wherein the width of the electrostatic discharge protection path is greater than 0.15 mm.
